(19) United States
(12) Patent Application Publication
(10) Pub. No.: US 2003/0136228 A1
(43) Pub. Date: Jul. 24, 2003

(54) Tool having a structure for removing damaged screws

(76) Inventor: Kuo Chen Liu, Taichung (TW)

Correspondence Address: Kuo Chen LIU, P.O. Box 63-99, Taichung, 406, TW

(21) Appl. No.: 10/051,127

(22) Filed: Jan. 22, 2002

(51) Int. Cl. B25B 13/50

(52) U.S. Cl. 81/53.2

(57) ABSTRACT

A tool for removing a threaded fastener having a damaged head from an object includes a shank having a drill head for drilling a hole in the damaged head of the threaded fastener, when the shank is rotated in a drilling direction. The shank includes one or more engaging surfaces for unthreading the damaged head and for disengaging the threaded fastener from the object when the shank is rotated in an opposite driving direction. The shank includes one or more cutting edges for drilling purposes, and one or more grooves for carrying borings formed during the drilling operation.

### BACKGROUND OF THE INVENTION

1. Field of the Invention

The present invention relates to a tool, and more particularly to a screw driver tool having a drilling structure for removing damaged threaded fasteners.

2. Description of the Prior Art

Typical screw drivers may be used for driving and rotating threaded fasteners, such as the screws or bolts. One of the typical threaded fasteners is shown in FIG. 1 and includes a shank 10 having a head 11 provided on one end and a “-” shaped or cross shaped groove 12 formed in the head 11 and defined by an engaging surface 14. After use, the grooves 12 and/or the engaging surface 14 in the head 11 may be damaged or flattened by the screw drivers, and thus may not be driven by the screw drivers. The damaged threaded fasteners 10 or bolts thus may not be easily disengaged and removed from the objects having the threaded fasteners 10 or bolts threaded thereon.

U.S. Design Pat. No. Des. 329,786 to Polonsky, U.S. Design Pat. No. Des. 340,184 to Desaulniers, U.S. Pat. No. 5,031,487 to Polonsky, and U.S. Pat. No. 5,251,516 to Desaulniers disclose four of the typical tools for extracting broken bolts, and comprise a drill bit section provided on one end thereof in order to drill a hole in the broken or damaged head of the fasteners, and comprise an extraction section formed and provided on the other end thereof distal to the drill bit section, such that the tool member should be disengaged from the driving tool and change the direction and engaged and secured to the driving tool again, for allowing the tool sections on the two ends of the tool members may be used. In addition, the typical tool members comprise a threaded extraction section for threading and disengaging the fasteners from the objects.

U.S. Pat. No. 4,604,917 to Polonsky discloses the other typical threaded fastener extractor and comprises an extractor slidably engaged on the drill bit shaft, enabling the drill bit to penetrate within the broken bolt before the extractor engages the bolt. However, the sliding engagement of the extractor on the drill bit shaft may not be used for extracting various kinds of fasteners.

The present invention has arisen to mitigate and/or obviate the afore-described disadvantages of the conventional tools.

### SUMMARY OF THE INVENTION

The primary objective of the present invention is to provide a tool including a drilling structure for removing damaged or flattened threaded fasteners.

In accordance with one aspect of the invention, there is provided a tool for removing a threaded fastener having a damaged head from an object, the tool comprising a shank including a first end having a drill head for conducting a drilling operation to drill a hole in the damaged head of the threaded fastener, when the shank is rotated in a drilling direction. The shank includes at least one engaging surface for engaging with and for unthreading the damaged head of the threaded fastener when the shank is rotated in an opposite driving direction.

The shank includes a cylindrical member provided on the first end and having an outer diameter greater than that of the drill head. The shank includes a frusto-conical intermediate portion provided between the drill head and the cylindrical member and having an inclined peripheral surface inclined from the cylindrical member toward the drill head.

The shank includes at least one cutting edge formed in the drill head, and at least one groove formed in the drill head and extended toward the cylindrical member and defined by the engaging surface of the shank for carrying borings.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view illustrating a typical threaded fastener;

FIG. 2 is a front plan view of a tool in accordance with the present invention;

FIG. 3 is an end view of the tool; and

FIG. 4 is a bottom plan view of the tool, illustrating the operation of the tool.

### DETAILED DESCRIPTION OF THE PREFERRED EMBODIMENT

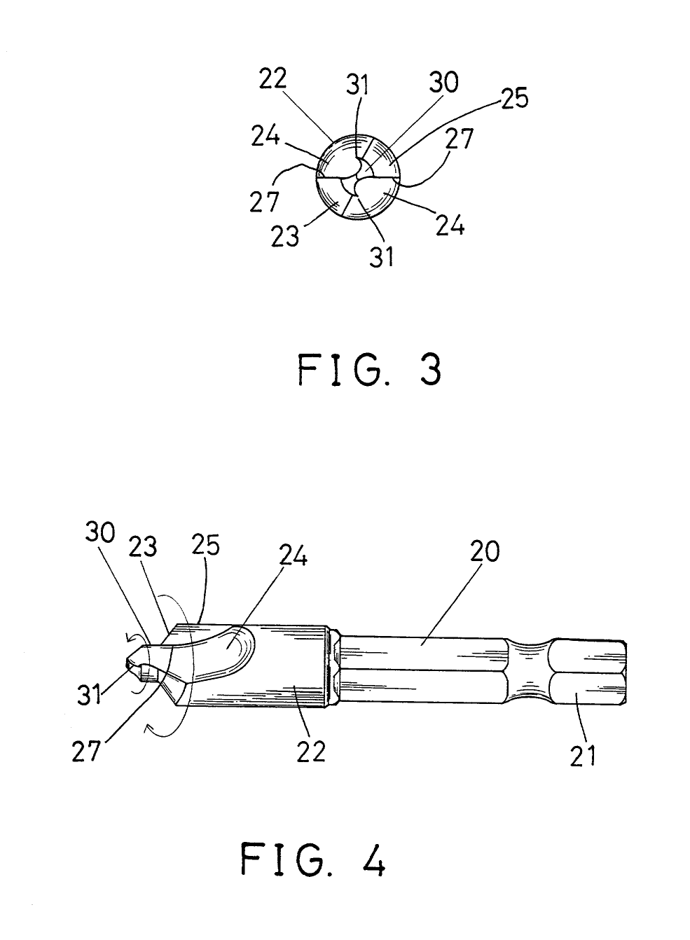

Referring to FIGS. 2-4, a tool in accordance with the present invention comprises a shank 20 including one end, such as the trailing end 21 having a hexagonal cross section, for example, formed therein for being rotated or driven by a driving tool, or for coupling to a power tool, such as a pneumatic driving tools a motor driving tool, or a hydraulic driving tool, etc. The shank 20 includes a cylindrical member 22 formed or provided on the other end thereof, such as the leading end of the shank 20, and includes a drill head 30 formed or extended from the free end or the leading end of the cylindrical member 22 and having an outer diameter smaller than that of the cylindrical member 22, and includes a frusto-conical intermediate portion 23 formed or provided between the drill head 30 and the cylindrical member 22 and having an inclined peripheral surface formed or inclined from the cylindrical member 22 toward the drill head 30.

The shank 20 includes one or more, such as two axially extending conducting channels or grooves 24 formed in the cylindrical member 22 and/or the drill head 30, for carrying the borings formed during the drilling operation away from the drill head 30, and includes one or more, such as two lands 25 formed or defined between the grooves 24 of the shank 20. The shank 20 includes one or more, such as two cutting edges 31 formed in the drill head 24 and/or formed in or extended toward the frusto-conical intermediate portion 23 and/or formed in or extended toward the cylindrical member 22, and leading the grooves 24 of the shank 20 for conducting the drilling operation. The shank 20 further includes one or more, such as two engaging surfaces 27 formed in the opposite side of the respective lands 25 and trailing the respective grooves 24 of the shank 20, particularly formed in the cylindrical member 22 and/or the frusto-conical intermediate portion 23, and parallel to the longitudinal direction of the shank 20.

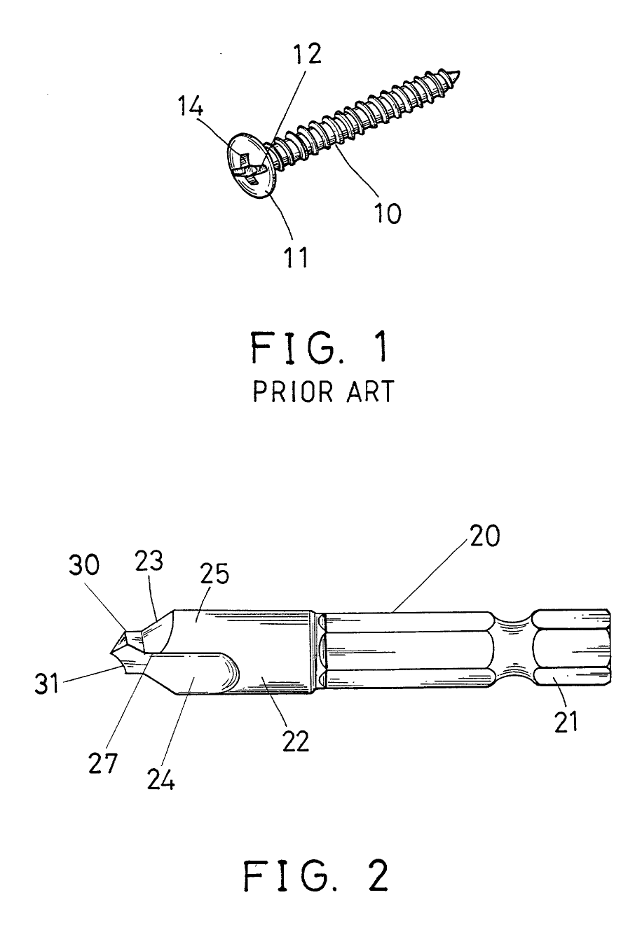

In operation, when the shank 20 is rotated or driven in one direction, such as in a drilling direction, the cutting edges 31 of the drill head 24 may be used for engaging into and for drilling a hole in the head 11 of the threaded fastener 10 (FIG. 1). After the head 11 of the threaded fastener 10 has been drilled with a hole, the shank 20 may be rotated or driven in the opposite direction, such as in the driving direction, the engaging surfaces 27 of the cylindrical member 22 and/or the frusto-conical intermediate portion 23 may be engaged with the engaging surface 14 of the screw head 11 (FIG. 1) and may be used for rotating or driving the head 11 of the threaded fastener 10 in order to unthread the threaded fastener 10 from the objects having the threaded fastener 10 threaded thereon.

Accordingly, the damaged screw head 11 may first be drilled with a hole by the drill head 30 which is rotated or driven in a drilling direction, and may then be rotated or unthreaded from the objects by the engaging surfaces 27 of the shank 20 which is rotated or driven in a driving direction. The shank 20 is not required to be disengaged from the driving tool and is not required to change the tool bits provided on the ends thereof.

Accordingly, the tool in accordance with the present invention includes a drilling structure for removing damaged or flattened threaded fasteners.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool for removing a threaded fastener having a damaged head from an object, said tool comprising:
a shank including a first end having a drill head extended therefrom for conducting a drilling operation to drill a hole in the damaged head of the threaded fastener, when said shank is rotated in a drilling direction, and
said shank including at least one engaging surface formed therein for engaging with and for unthreading the damaged head of the threaded fastener when said shank is rotated in an opposite driving direction.

2. The tool according to claim 1, wherein said shank includes a cylindrical member provided on said first end thereof and having an outer diameter greater than that of said drill head.

3. The tool according to claim 2, wherein said shank includes a frusto-conical intermediate portion provided between said drill head and said cylindrical member and having an inclined peripheral surface formed thereon and inclined from said cylindrical member toward said drill head.

4. The tool according to claim 1, wherein said shank includes at least one cutting edge formed in said drill head for drilling purposes, and at least one groove formed in said drill head for carrying borings formed during the drilling operation.

5. The tool according to claim 4, wherein said shank includes a cylindrical member provided on said first end thereof and having an outer diameter greater than that of said drill head, said at least one groove of said shank extends toward said cylindrical member and defined by said at least one engaging surface of said shank.

6. A tool for removing a threaded fastener having a damaged head from an object, said tool comprising:
a shank including a first end having a drill head extended therefrom for conducting a drilling operation to drill a hole in the damaged head of the threaded fastener, when said shank is rotated in a drilling direction, and
said shank including a pair of engaging surfaces formed therein for engaging with and for unthreading the damaged head of the threaded fastener when said shank is rotated in an opposite driving direction.

7. The tool according to claim 6, wherein said shank includes a cylindrical member provided on said first end thereof and having an outer diameter greater than that of said drill head, and includes a pair of grooves formed in said drill head and said cylindrical member, and includes a pair of lands formed between said pair of grooves, and includes a pair of cutting edges formed in said drill head and leading said grooves of said shank for drilling purposes.
